(19) United States
(12) Patent Application Publication
(10) Pub. No.: US 2011/0179649 A1
(43) Pub. Date: Jul. 28, 2011

(54) PIPE CUTTER HAVING A DETACHABLE CUTTING HEAD

(76) Inventor: Keith Park, (US)

(21) Appl. No.: 13/010,477

(22) Filed: Jan. 20, 2011

(30) Foreign Application Priority Data
Jan. 26, 2010 (CN) CN201010110717.3

(51) Int. Cl. B23D 21/04

(52) U.S. Cl. 30/95

(57) ABSTRACT

The present invention provides a pipe cutter, which has a main body, a rotary cutting head disposed on the main body, and the cutting head is detachably mounted to a front portion of the main body via a retaining mechanism. As a result, an operator can select a cutting head of proper size to quickly adapt to different working circumstances or machining operations.

### CROSS-REFERENCE TO RELATED APPLICATIONS

This application claims priority to CN 201010110717.3, filed Jan. 26, 2010, which is hereby incorporated by reference.

### FEDERALLY SPONSORED RESEARCH OR DEVELOPMENT

Not Applicable.

### TECHNICAL FIELD

The present invention relates to a power tool, and especially to a pipe cutter.

### BACKGROUND OF THE INVENTION

Pipes often need to be cut during pipe layout work, and pipe cutters are widely used because of their high efficiency, convenience and ease of operation. A pipe cutter generally comprises a main body and a cutting head located at the front of the main body. The cutting head is driven by the cooperation of a motor and a transmission mechanism in the main body so the cutting head can be rotated relative to a pipe, a portion of which to be cut is clamped by the cutting head. As a result, the pipe can be cut off by a cutting wheel or a cutting blade, which is mounted on the cutting head and contacts an external surface of the portion of the pipe to be cut. Currently, the cutting head of the pipe cutter is generally large in order to allow for the cutting of pipes of different diameters. Because of the large cutting head, the current pipe cutters cannot be used in compact spaces as defined by brackets that support the pipes of smaller diameters. Current pipe cutters are also assembled with only one kind of cutting member for one kind of material. Moreover, other tools are necessary if other machining operations, such as cutting-edge burring or outer surface polishing is needed. In sum, the use of current pipe cutters is limited.

### SUMMARY OF THE INVENTION

In one embodiment, the present invention provides a pipe cutter having a detachable cutting unit so that the pipe cutter can work with a selected and proper cutting unit to adapt to different working occasions and/or different machining operations. The pipe cutter may have a main body, a rotary cutting head disposed on the main body, with the cutting head being detachably mounted to the main body via a retaining mechanism. The pipe cutter may also have a main body, a motor disposed in the main body, a transmission assembly disposed in the main body, and at least two cutting heads, which allow for cutting pipes of different diameters, that are provided to be selectively and releasably retained to the main body via a retaining mechanism.

The pipe cutter according the present invention constitutes advantages that the cutting head may be detachably mounted on the main body via a retaining mechanism so that an operator can select a proper cutting head to adapt different working occasions and/or different machining operations.

### BRIEF DESCRIPTION OF THE DRAWINGS

The subject pipe cutter will become apparent from the following detailed description and accompanying drawings.

FIG. 1 is a perspective view of a pipe cutter according to one embodiment of the present invention;

FIG. 2 is a side view of the internal structure of the main body of the pipe cutter according to the present invention;

FIG. 3 is a side view of the internal structure of a cutting head of the pipe cutter according to the present invention, where a portion of housing of the cutting head is removed and a cutting member is at the starting position of cutting;

FIG. 4 is a side view of the cutting head shown in FIG. 3 where the cutting member is at the ending position of cutting;

FIG. 5 is a perspective view of a first cutting head assembly mounted to the pipe cutter for a pipe of a first diameter according the present invention;

FIG. 6 is a perspective view of a second cutting head assembly mounted to the pipe cutter for a pipe of a second diameter according to the present invention;

FIG. 7 is a side view of the pipe cutter according to the present invention with the cutting head assembly mounted to the main body and a retaining mechanism in a first position; and,

FIG. 8 is a side view of the pipe cutter according to the present invention with the cutting head assembly being capable of being removed from the main body and the retaining mechanism in a second position.

### DETAILED DESCRIPTION

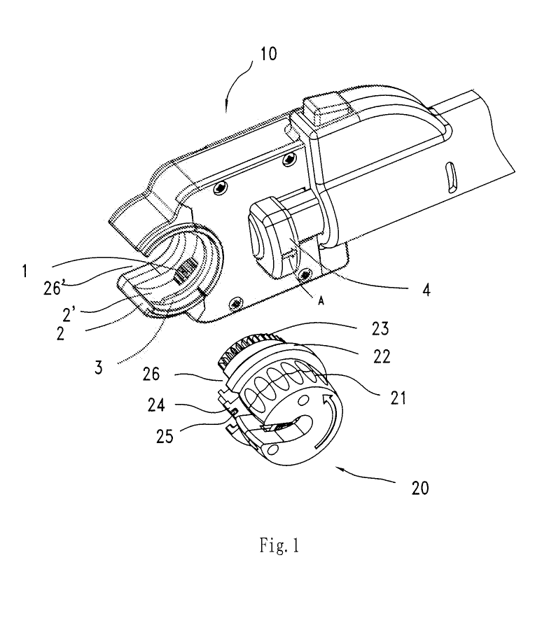

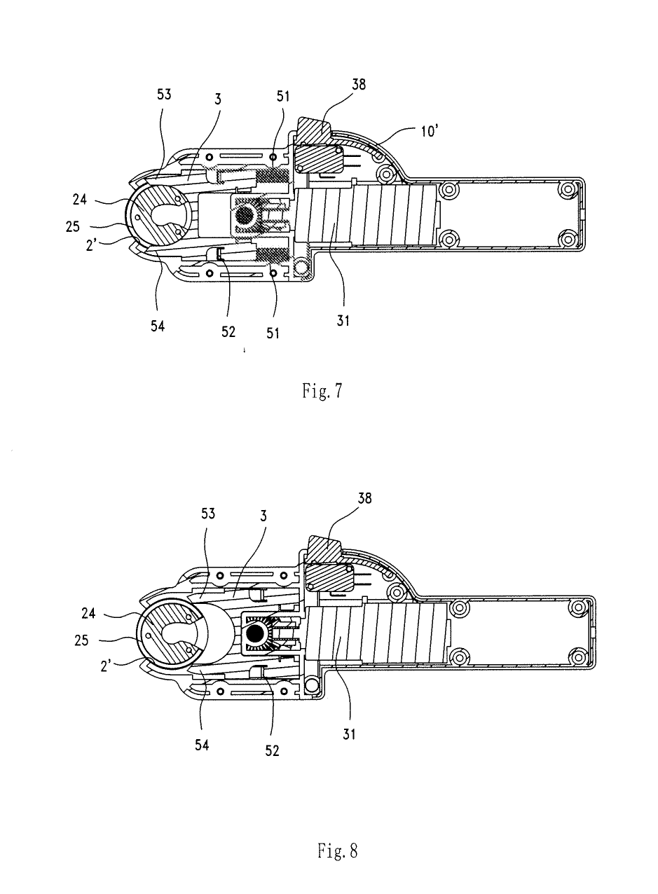

As shown in FIGS. 1-8, a pipe cutter according to one embodiment of the present invention comprises a main body 10 and a detachable cutting head assembly 20 mounted to a front end of the main body. The main body 10 is configured to comprise a substantially C-shaped front portion 2 shaped to have a concave surface 2′ to define an opening 26′. A first idler gear 1 and a second idler gear 35 are mounted in the main body 10 with a portion of each idler gear exposed out of the surface 2′ of the front portion 2. A retaining member, which is a retaining plate 3 in the present embodiment, is mounted in the main body 10. As shown in FIG. 7, the retaining plate 3 is partially exposed out of the surface 2′ of the front portion 2 when the retaining plate 3 is located on its first position. An actuating member 4 is mounted to the main body 10 and at least partially protrudes out thereof so that the actuating member 4 can be conveniently contacted by an operator. In the present embodiment, the actuating member 4 is embodied as a movable knob. Those skilled in the art can understand that the actuating member can be mounted to the main body at other positions to increase the convenience of the operator, and the actuating member can be another type of member or unit. The retaining plate 3 and the actuating member 4 are connected with each other. When the actuating member 4 is moved backwards, e.g., along a direction indicated by an arrow A, under the effect of an outside force, the retaining plate 3 is forced to retract into the main body to reach a second position, as shown in FIG. 8.

The cutting head assembly is substantially C-shaped with an opening 26 being formed at the opening of the C shape for accepting a pipe. The cutting head assembly 20 comprises a substantially C-shaped head gear 23, a substantially C-shaped cutting head 21, and a substantially C-shaped connecting member 24. One end of the connecting member 24 close to the cutting head 20 is fixedly connected to the cutting head 20 via a flange 22 formed at the end of the connecting member 24. And the other end of the connecting member 24 is fixedly mounted to the head gear 23. An external surface of the connecting member 24 is shaped to adapt to the concave surface 2′ of the front portion 2 and the connecting member 24 can be rotatably inserted in a space defined by the concave surface 2′. The connecting member 24 comprises a periphery retaining recess 25 which is slumped from the external surface of the connecting member 24 and shaped to adapt the shape of the retaining plate 3. In order to mount the cutting head assembly to the main body of the pipe cutter, the actuating member 4 is actuated to move the retaining plate 3 to its second position so that the connecting member 24 can be inserted into the C-shaped front portion 2, then the actuating knob 4 is released so as to release the retaining plate 3 back to its first position under an elastic force of the springs 51 with the retaining plate 3 being partially extended out of the surface 2′ of the front portion 2 to insert into the periphery recess 25 of the connecting member 24, as shown in FIG. 7, and the connecting member 24 is fixed to the front portion 2 of the main body 10 thereby. Meanwhile, the head gear 23 is engaged to the first idler gear 1 and the second idler gear 35 so that when the two idler gears 1 and 35 rotate the head gear 23 fixedly connected to the connecting head assembly 20 is driven to rotate therewith. In order to detach the cutting head assembly 20 from the main body, the actuating member 4 is actuated to move backward to drive the retaining plate 3 to retract to its second position and be released from contacting with the periphery recess 25 of the connecting member 24, as shown in FIG. 8, and then the cutting head assembly can be removed from the front portion 2 of the main body. In this way, the operator can select a proper cutting head from at least two different cutting head assemblies and mount it to the main body of the pipe cutter for desired machining operation. In other embodiments according to the present invention, the connecting member may be formed directly on the cutting head.

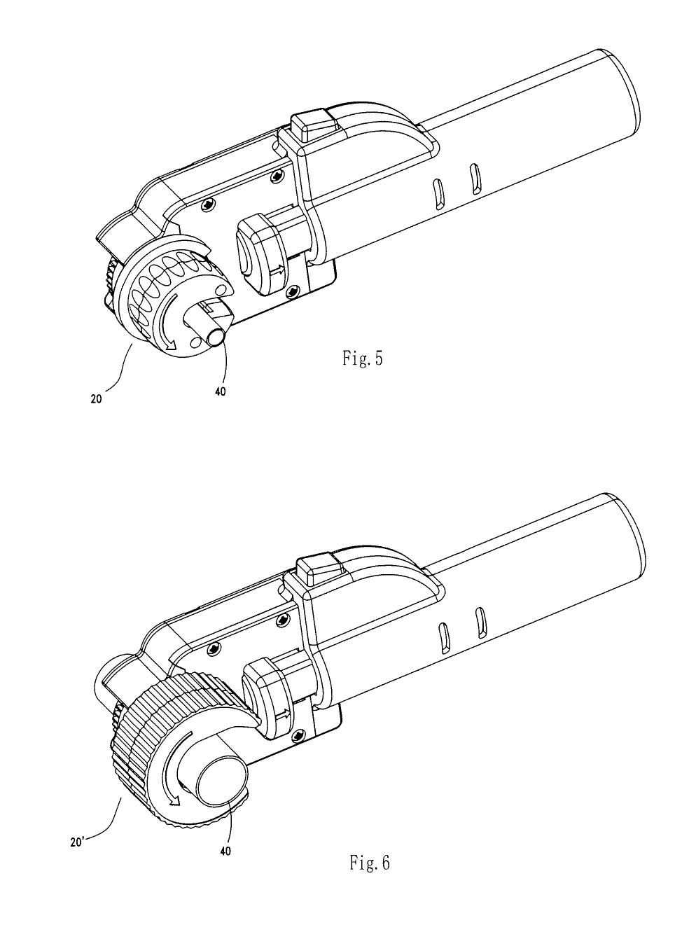

In a first example, the main body of the pipe cutter having a detachable cutting head assembly can provide for the cutting of pipes of a diameter ranging from 0.5 to 1.125 inches and pipes of different materials such as plastic, steel, copper and the like. The pipe cutter may also provide cutting-edge burring operations, outer surface polishing operations and the like. For example, as shown in FIGS. 5 and 6, the pipe cutter is mounted with cutting head assembly 20, 20′ for different pipe 40, 40′, respectively. And the size of the cutting head assembly 20 is different than the cutting head assembly 20′.

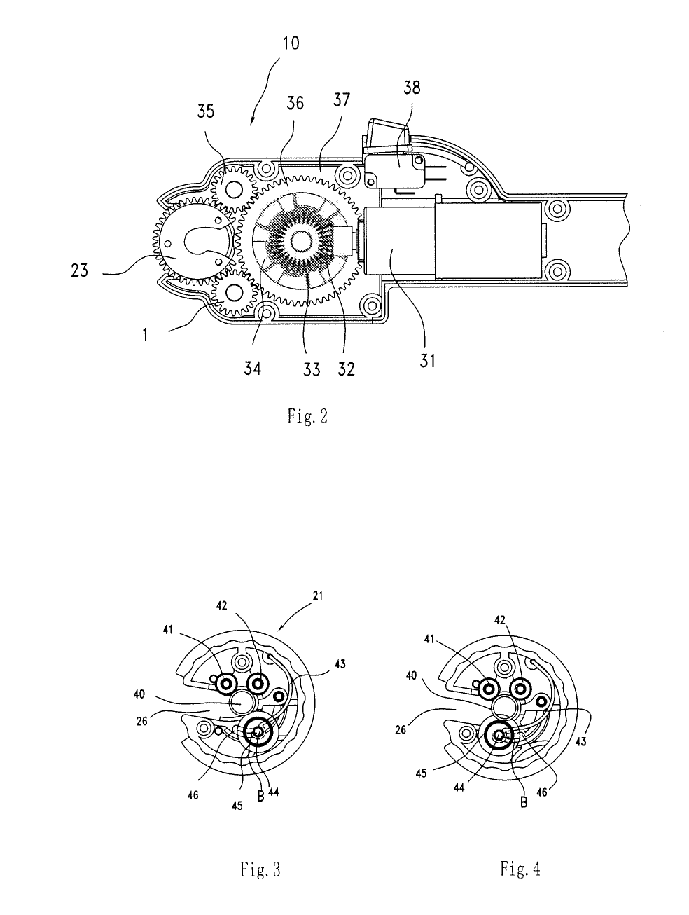

A switch 38 for controlling ON/OFF of a motor 31 is arranged on the main body 10 and partially exposed out of the housing 10′ of the main body. A motor 31 and transmission mechanism are arranged in the housing 10′ of the main body 10. The transmission mechanism comprises a bevel pinion 32, a bevel gear 33, a drive gear 36, the first idler gear 1, and the second idler gear 35. The bevel pinion 32 is mounted on an output shaft of the motor 31 and engaged with the bevel gear 33. The bevel gear 33 is arranged to connect the drive gear coaxially. The drive gear 36, the first and the second idler gears 1 and 35 are fixedly mounted in the housing 10′ of the main body 10. The drive gear 36 is arranged to engage with both the first idler gear 1 and the second idler gear 2, while the first and the second idler gears 1 and 35 are symmetrically arranged so two sides of the drive gear 36 are separated from each other. A clutch 34, which allows one-way transmission, is arranged between the bevel gear 33 and the drive gear 36. The clutch 34 generally comprises two clutch portions coaxially with each other which connect to the bevel gear 33 and the drive gear 36, respectively. The two clutch portions can engage with each other along the transmission direction so that power transmission is achieved when the motor works. In a direction opposite to the transmission direction, the two clutch portions can be rotated with each other so that the operator can rotate the cutting head assembly by hand to align the opening 26 of the cutting head assembly with the opening 26′ of the front portion 2 of the main body 10 to create an opening for the pipe if the openings 26 and 26′ are misaligned after the motor is stopped. In the present embodiment, the clutch 34 is embodied as a wedge-one-way clutch, which is known to those of ordinary skill in the art. Those skilled in the art can understand that other types of one-way clutches, for example a roller-one-way clutch, may also be useful in other embodiments according to the present invention. Referring to FIGS. 1 and 2, the first and the second idler gears 1 and 35 can engage with the C-shaped head gear 23, and the spaced arrangement of the first idler gear 1 and the second idler gear 35 insures at least one of the first idler gear 1 and the second idler gear 35 engages the head gear 23 for continuous rotation of the head gear when an opening of the C-shaped head gear 23 is moved to a position between the first idler gear 1 and the idler gear 35.

In order to complete a cutting operation, a portion of the pipe 40 to be machined is positioned in a space defined by a first supporting roller 41, a second supporting roller 42 and a cutting member 45, wherein the first and the second supporting rollers 41 and 42 can rotate relative to the pipe while supporting the pipe. The first and the second supporting rollers 41 and 42 depart from each other by a distance, and external cylinder surfaces of them linearly contact an external surface of the pipe 40. The cutting member 45, a cutting periphery of which contacts the external surface of the pipe 40, is disposed opposite to the first and the second supporting rollers 41 and 42. As known by those skilled in the art, the cutting member can be a small circular abrading disc, a circular cutting blade, or other members being properly shaped and capable of completing cutting via rotating motions. The cutting member 45 is mounted on a shaft 44. An eccentric arc groove 46 is arranged to be formed in one half housing of the cutting head 21, and the other eccentric arc groove (not shown in the drawings) corresponding to the groove 46 is formed in the other half housing of the cutting head 21. Two ends of the shaft 44 are inserted in the two eccentric arc grooves, respectively, and capable of moving therein. A wire spring 43 has one end fixedly mounted in the housing of the cutting head 21 and the other end is connected to the shaft 44, so that the wire spring 43 can force the shaft 44 to press the cutting member 45 onto the pipe 40. When the portion of the pipe 40 to be machined is moved into the opening of the C-shaped cutting head 21, the cutting head 45 is pushed, by the pipe 40, together with the shaft 44 to overcome an elastic force of the wire spring 43 to move to a cutting beginning position along a direction reversing to a direction indicated by an arrow B, as shown in FIG. 3, while the cutting member 45 is pressed onto the pipe 40 due to the elastic force of the wire spring 43 so that the pipe 40 is held by cooperation of the cutting member 45, the first and the second supporting rollers 41 and 42. When the cutting head 21 is driven to continuously rotate relative to the pipe 40, the cutting member 45 can effectively remove portions of the pipe which contact the cutting periphery of the cutting member 45 due to the continuous pressing force on the pipe 40 by the cutting member 45, and the shaft 44 connected to the cutting head is forced thereby to move in the eccentric arc grooves along the direction indicated by the arrow B. Under the cooperation of the wire spring 45, the eccentric arc grooves, and the cutting member 45, the cutting member 45 moves toward the elongated axis of the pipe 40 to achieve radius feed of cutting to the pipe 40, until the pipe 40 is completely cut off and the cutting member 45 reaches a cutting ending position, as shown in FIG. 4. As known by those skilled in the art, the wire spring 43 can be replaced by other types of biasing members or biasing devices, and the transmission assembly can arranged in other configurations as described previously.

In the another embodiment, the cutting head is detachably mounted to the main body of the pipe cutter via a releasable retaining mechanism embodied to be a retaining plate 3 and the retaining recess 25, as shown in FIGS. 7 and 8. FIG. 7 shows a first state of the retaining mechanism when the cutting head assembly is mounted to the main body, with the retaining plate 3 located in a first position where the retaining plate 23 engages with the retaining recess 25. FIG. 8 shows a second state of the retaining mechanism when the cutting head can be removed from the main body, with the retaining plate 3 located in a second position where the retaining plate 23 disengages from the retaining recess 25. The front portion of the retaining plate 3 is shaped to adapt to the shape of the retaining recess 25. Preferably, the front portion of the retaining plate 3 is substantially C-shaped and has a first arm 53 and a second arm 54. When the retaining plate 3 is in the first position, the length of each of the two arms 53 and 54 is provided to insure at least one of the two arms 53 and 54 extends in the retaining recess 25 for continuously retaining while the retaining recess 25 rotates along with the connecting member 24. Two tabs, which are connected to the actuating member 4, are disposed on the retaining plate 3 symmetrically relative to a middle line of the retaining plate 3. Two springs 51 are provided to force on the retaining plate 3 so that the retaining plate 3 is trended to move to engage with the retaining recess 25. Those skilled in the art can understand that the retaining member and the retaining recess can be shaped to be other forms.

Those skilled in the art can easily understand that detachably mounting the cutting head to of the main body is not limited to the front portion of the main body and other types of the retaining mechanism can be used.

The pipe cutter according to the present invention is configured to be compact and convenient to adapt to different working occasions and different machining operations, which widens the application of the pipe cutter. The present invention is not restricted to the embodiments disclosed hereinabove. Accordingly, any substitutes and modifications according to the spirit of the present invention will be regarded as falling within the following claims.

What is claimed is:

1. A pipe cutter, comprising:
a main body, and
a rotary cutting head disposed on the main body,
wherein, the cutting head is detachably mounted to the main body via a retaining mechanism.

2. A pipe cutter according to claim 1, wherein, the retaining mechanism comprises a retaining recess and a retaining member, and the retaining member can be selectively moved to a first position, where the retaining member engages with the retaining recess, and a second position, where the retaining member disengages from the retaining recess.

3. A pipe cutter according to claim 2, wherein the retaining mechanism is releasable.

4. A pipe cutter according to claim 3, wherein the retaining mechanism further comprises at least one spring which acts on the retaining member so that the retaining member trends to move towards the first position.

5. A pipe cutter according to claim 2, wherein the retaining member is provided with at least one tab thereon.

6. A pipe cutter according to claim 5, wherein an actuating member is disposed on a housing of the main body, the actuating member is connected with the tab.

7. A pipe cutter according to claim 2, wherein the retaining member is disposed in the main body, and a front portion of the retaining member is capable of extending out of the main body.

8. A pipe cutter according to claim 2, wherein the retaining recess is provided on a connecting member which connects with the cutting head.

9. A pipe cutter according to claim 8, wherein the connecting member is substantially C-shaped, and the retaining recess extends along the periphery of an external cylinder surface of the C-shaped connecting member.

10. A pipe cuter according to claim 9, wherein a front portion of the retaining member is substantially C-shaped to adapt to the retaining recess.

11. A pipe cutter, comprising:
a main body,
a motor disposed in the main body, and
a transmission assembly disposed in the main body,
wherein at least two cutting heads are provided to be selectively and releasably retained, one of them to the main body via a retaining mechanism.

12. A pipe cutter according to claim 11, wherein an actuating member is disposed on a housing of the main body, and the actuating member is connected to the retaining mechanism.

13. A pipe cutter according to claim 12, wherein the retaining mechanism comprises a retaining recess and a retaining member, and the retaining member can be selectively movable to a first position, where the retaining member engages with the retaining recess, and a second position, where the retaining member disengages from the retaining recess, and the retaining mechanism further comprises at least one spring which acts on the retaining member so that the retaining member trends to move towards the first position.

14. A pipe cuter according to claim 13, wherein a portion of the retaining member is substantially C-shaped to adapt to the retaining recess.

15. A pipe cutter according to claim 13, wherein the retaining member is disposed in the main body, and a portion of the retaining member is capable of selectively extending out of and retracting into the main body.

16. A pipe cutter according to claim 13, wherein the retaining recess is provided on a connecting member which connects with the cutting head.

17. A pipe cutter according to claim 16, wherein the connecting member is substantially C-shaped, and the retaining recess extends along a periphery of an external cylinder surface of the C-shaped connecting member.
